(19) United States
(12) Patent Application Publication
(10) Pub. No.: US 2012/0236927 A1
(43) Pub. Date: Sep. 20, 2012

(54) TRANSMISSION APPARATUS, TRANSMISSION METHOD, AND RECORDING MEDIUM

(75) Inventor: Toshiyuki Nakagawa, Kawasaki-shi (JP)

(73) Assignee: CANON KABUSHIKI KAISHA, Tokyo (JP)

(21) Appl. No.: 13/419,044

(22) Filed: Mar. 13, 2012

(30) Foreign Application Priority Data
Mar. 17, 2011 (JP) 2011-059248

(51) Int. Cl. H04N 7/12

(52) U.S. Cl. 375/240.01; 375/E07.026

(57) ABSTRACT

A transmission apparatus capable of transmitting moving image data at a plurality of different frame rates includes an acquisition unit configured to acquire status information about the transmission apparatus, a transmission unit configured to transmit moving image data, and a change unit configured to, when the transmission unit is transmitting the moving image data at a first frame rate and a second frame rate which is lower than the first frame rate and if the frame rates of the moving image data which is being transmitted are reduced according to the status information, reduce the first frame rate and the second frame rate so that a reduction rate of the first frame rate with respect to the first frame rate is higher than a reduction rate of the second frame rate with respect to the second frame rate.

### BACKGROUND OF THE INVENTION

1. Field of the Invention

The present invention relates to a transmission apparatus for transmitting moving image data, a transmission method, and a recording medium.

2. Description of the Related Art

A streaming technology for transmitting and receiving moving image data over a network in real time has been put to practical use in recent years. Examples of such technology include a network camera and a video conference system. A method for thinning frames according to the transmission speed of a network while transmitting moving image data has conventionally been known (for example, Japanese Patent Application Laid-Open No. 2003-309847).

A description will be given of an example where a processing load of a transmission apparatus exceeds a threshold when the transmission apparatus is transmitting moving image data to a first client at a frame rate of 60 frames per second (fps) and to a second client at 10 fps. In such a case, if the frame rates of the moving image data transmitted to the respective clients is reduced by half, the resulting frame rate of the moving image data transmitted to the second client, 5 fps, can make the contents of the moving image difficult to understand.

For another example, suppose that a transmission apparatus transmits first moving image data at 60 fps and second moving image data at 10 fps to an identical client. Reducing each frame rate by half according to the processing load of the transmission apparatus can make the frame rate of the second moving image too low.

### SUMMARY OF THE INVENTION

The present invention is directed to reducing the possibility that a certain piece of moving image data may become too low in quality because of a change in a frame rate when moving image data is transmitted at a plurality of different frame rates.

According to an aspect of the present invention, a transmission apparatus capable of transmitting moving image data at a plurality of different frame rates includes an acquisition unit configured to acquire status information about the transmission apparatus, a transmission unit configured to transmit moving image data, and a change unit configured to, when the transmission unit is transmitting the moving image data at a first frame rate and a second frame rate which is lower than the first frame rate and if the frame rates of the moving image data which is being transmitted are reduced according to the status information, reduce the first frame rate and the second frame rate so that a reduction rate of the first frame rate with respect to the first frame rate is higher than a reduction rate of the second frame rate with respect to the second frame rate.

According to the present invention, it is possible to reduce the possibility that a certain piece of moving image data may become too low in quality because of a change in a frame rate when moving image data is transmitted at a plurality of different frame rates.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example of a functional configuration of a transmission apparatus 100.

FIG. 2 is a flowchart illustrating processing of the transmission apparatus 100.

FIG. 3 illustrates an example of a system configuration according to an exemplary embodiment.

FIG. 4 illustrates a relationship between a CPU load and frame rates.

FIG. 5 is a block diagram illustrating an example of a functional configuration of a transmission apparatus 500.

FIG. 6 is a flowchart illustrating processing of the transmission apparatus 500.

### DESCRIPTION OF THE EMBODIMENTS

Various exemplary embodiments, features, and aspects of the invention will be described in detail below with reference to the drawings.

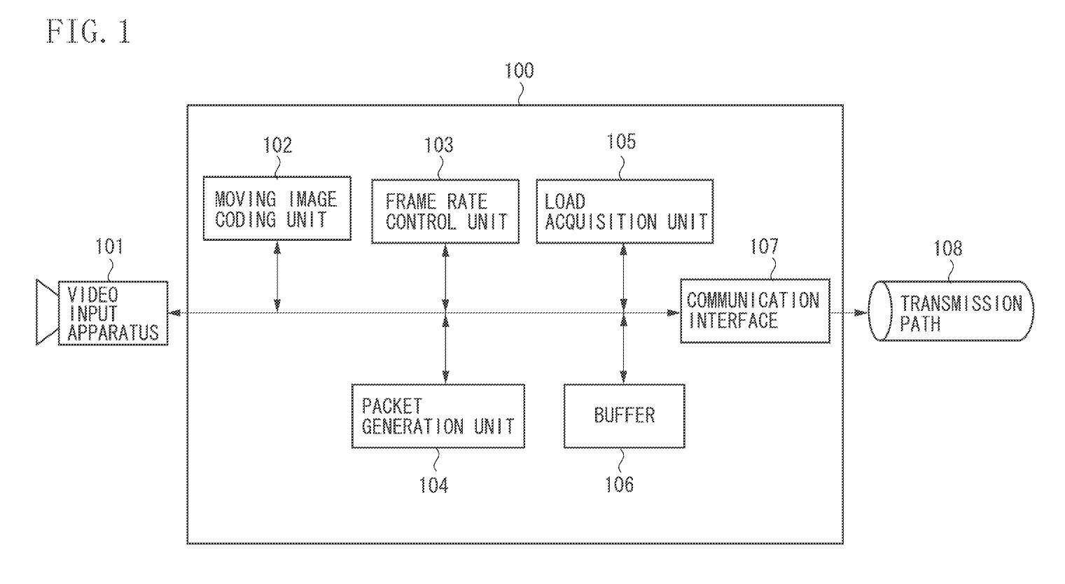

FIG. 1 is a block diagram illustrating an example of a functional configuration of a transmission apparatus 100 according to a first exemplary embodiment of the present invention. The transmission apparatus 100 according to the present exemplary embodiment is a transmission apparatus that can transmit moving image data at a plurality of different frame rates.

As illustrated in FIG. 1, the transmission apparatus 100 according to the present exemplary embodiment includes a moving image coding unit 102, a frame rate control unit 103, a packet generation unit 104, a load acquisition unit 105, a buffer 106, and a communication interface 107. The transmission apparatus 100 is connected to a video input apparatus 101 and a transmission path 108.

The video input apparatus 101 is an apparatus that can input moving image data to be transmitted to a reception apparatus. Examples of the video input apparatus 101 include a video camera and a web camera. The video input apparatus 101 may be integrated with the transmission apparatus 100.

The transmission apparatus 100 can be implemented as an apparatus such as a personal computer, a workstation, a notebook personal computer (PC), various types of home electric appliances with a built-in computer, a game machine, a cellular phone, a digital video camera, and a digital camera, or a combination of such apparatuses.

The transmission path 108 is typified by a variety of networks. In the present exemplary embodiment, the transmission path 108 is a network for transmitting and receiving various types of packets including moving image data. Data to be transmitted and received is temporarily stored in the buffer 106.

The moving image coding unit 102 compresses and codes moving image data input from the above-described video input apparatus 101 by the motion-joint photographic experts group (Motion-JPEG) method. Moving image data has too large an amount to transmit directly, and is thus compressed and coded before transmission.

The coding method of the moving image coding unit 102 is not limited to one that performs coding without referring to moving image data on other frames (intra-picture coding method) similar to the Motion-JPEG method. For example, a coding method of performing coding with reference to moving image data on other frames (inter-picture coding method) similar to the H.264 method may be used.

In the case of performing coding by the inter-picture coding method, the frame rate control unit 103, which is described below, performs frame rate control, and then the moving image coding unit 102 codes the resulting moving image data. This can prevent the other frames referred to from being thinned by the frame rate control and failing to be decoded.

The moving image coding unit 102 inputs the compressed and coded moving image data into the packet generation unit 104 frame by frame.

The packet generation unit 104 packetizes the moving image data input from the moving image coding unit 102, and stores the resulting packets into the buffer 106. In the present exemplary embodiment, the packet generation unit 104 uses Motion-JPEG as a method for coding moving image data, and uses the real-time transport protocol (RTP) as a protocol for transferring coded moving image data. Thus, the packet generation unit 104 packetizes the coded moving image data according to the Internet Engineering Task Force (IETF) Request For Comments (RFC) 2435 which defines an RTP payload format for moving image data that is coded by Motion-JPEG.

The frame rate control unit 103 controls a frame rate of moving image data, and reads moving image packets stored in the buffer 106 to transmit the read moving image packets to the reception apparatus based on the controlled frame rate.

For example, the frame rate control unit 103 adds a time stamp to coded data and transmits the resulting coded data. The reception apparatus reproduces the coded data at a time corresponding to the time stamp, so that the coded data can be transmitted at a predetermined frame rate. The frame rate control method used in the frame rate control unit 103 will be described in detail below.

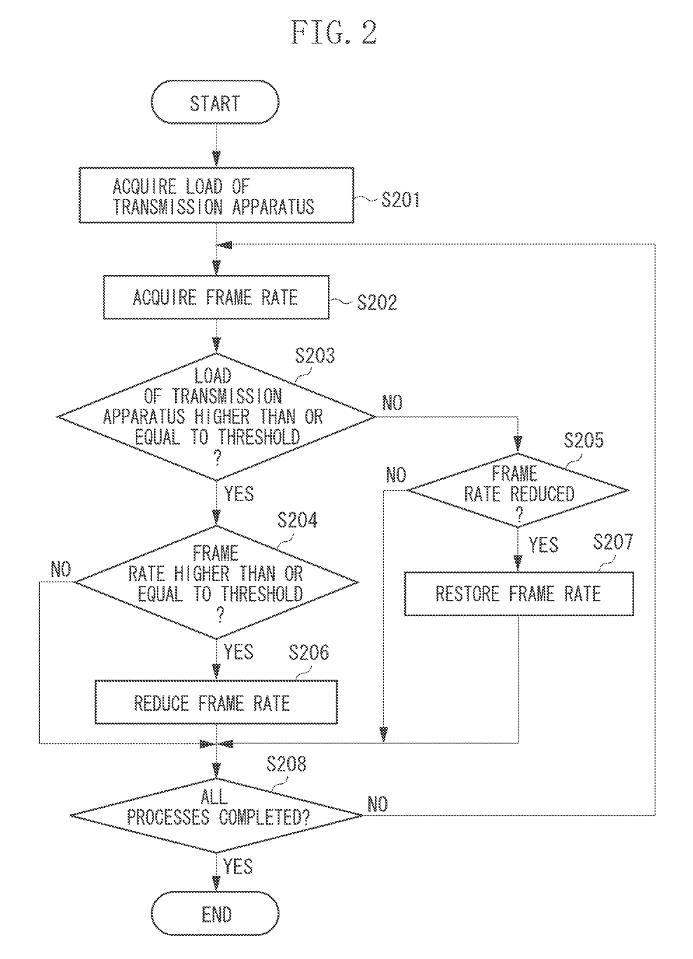

Next, frame rate control processing of the transmission apparatus 100 according to the present exemplary embodiment will be described in detail with reference to FIG. 2. FIG. 2 is a flowchart illustrating the frame rate control processing of the transmission apparatus 100 according to the present exemplary embodiment.

The transmission apparatus 100 according to the present exemplary embodiment is a transmission apparatus that can transmit moving image data at a plurality of different frame rates. The transmission apparatus 100 according to the present exemplary embodiment performs the processing illustrated in FIG. 2 by its central processing unit (CPU) reading and executing a program for executing the processing illustrated in FIG. 2. At least a part of the processing illustrated in FIG. 2 may be performed by dedicated hardware. The transmission apparatus 100 according to the present exemplary embodiment starts the processing illustrated in FIG. 2 at timing when the transmission apparatus 100 starts transmitting moving image data to the reception apparatus.

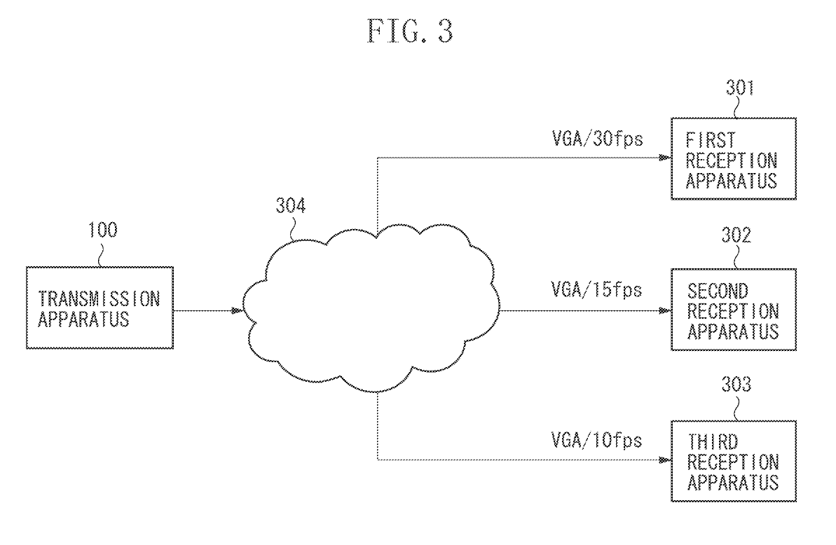

As illustrated in FIG. 3, the transmission apparatus 100 according to the present exemplary embodiment transmits moving image data to a plurality of reception apparatuses 301 to 303. As illustrated in FIG. 3, the transmission apparatus 100 transmits moving image data to the first reception apparatus 301 at 30 fps, to the second reception apparatus 302 at 15 fps, and to the third reception apparatus 303 at 10 fps. The transmission apparatus 100 according to the present exemplary embodiment transmits different pieces of moving image data to the plurality of reception apparatuses 301 to 303 at different frame rates. The pieces of moving image data to be transmitted to the respective reception apparatuses 301 to 303 may be based on the same input contents from the video input apparatus 101.

In step S201, the load acquisition unit 105 acquires the current processing load of the transmission apparatus 100. For example, the load acquisition unit 105 acquires the processing load of a processing unit (CPU) that performs a plurality of processing procedures including one for transmitting a plurality of pieces of moving data as status information.

However, the processing load is not limited to such an example. The load acquisition unit 105 may acquire, as the current processing load, a time difference between time when moving image data is input from the video input apparatus 101 and time when a packet of the moving image data is transmitted and a time difference between time of input of the moving image data and time of generation of a moving image packet. The load acquisition unit 105 may acquire a time difference between the time of generation and the time of transmission of a moving image packet as the current processing load. Such time differences correspond to processing time of the transmission apparatus 100. In the present exemplary embodiment, the greater the acquired time difference is, the higher the current processing load is determined to be.

The transmission apparatus 100 may determine the current processing load by combining information about the CPU load and the time difference. The load acquisition unit 105 may acquire the load of the CPU of the transmission apparatus 100 from an operating system (OS). The load acquisition unit 105 may acquire an amount of data or the number of frames of the moving image data that is stored in the buffer 106 and waiting for transmission, in addition to the processing load of the transmission apparatus 100. More specifically, in step S201 (i.e., acquisition procedure), the load acquisition unit 105 of the transmission apparatus 100 acquires status information about the transmission apparatus 100 (such as information about the processing load and condition of the buffer 106). The following description deals mainly with the case of acquiring a processing load as the status information.

The load acquisition unit 105 according to the present exemplary embodiment acquires the current processing load at regular intervals. However, the load acquisition unit 105 may acquire a processing load according to situations such as when error packets increase, when transmission of new moving image data is started, and when transmission of existing moving image data is completed.

In step S202, the frame rate control unit 103 acquires the value of a frame rate of the moving image data transmitted to each reception apparatus. If the transmission apparatus 100 is transmitting the moving image data to the first, second, and third reception apparatuses 301, 302, and 303, the frame rate control unit 103 first acquires an initial frame rate and the current frame rate of the moving image data transmitted to the first reception apparatus 301.

The initial frame rate refers to the value of a frame rate that is determined in advance of transmission of RTP packets (moving image packets) by performing communication between the transmission apparatus and the reception apparatus, using control protocols such as the real time streaming protocol (RTSP), session description protocol (SDP), session initiation protocol (SIP), and simple object access protocol (SOAP).

The current frame rate has the same value as that of the initial frame rate unless frame rate control to be described below is performed. When the frame rate of the moving image data transmitted to the first reception apparatus 301 and the initial frame rate are acquired in step S202, the processing proceeds to step S203.

In step S203, the frame rate control unit 103 determines whether the processing load acquired by the load acquisition unit 105 in step S201 is higher than or equal to a threshold. The threshold may be set to an arbitrary value. For example, the transmission apparatus 100 according to the present exemplary embodiment uses 80% of a CPU load as the threshold.

However, the threshold is not limited to 80%. For example, a difference between the input time of the moving image data and the transmission time of the packet of the moving image data (100 milliseconds) may be set as the threshold. A time difference between the time of generation and the time of transmission of the packet of the moving image data (30 milliseconds) may be set as the threshold. The frame rate control unit 103 may determine whether the current processing load is higher than or equal to the threshold based on a combination of a plurality of thresholds described above.

In step S203, if the processing load is determined to be higher than or equal to the threshold (YES in step S203), then in step S204, the frame rate control unit 103 determines whether the current frame rate acquired in step S202 is higher than or equal to a threshold. The threshold may be an arbitrary value. The transmission apparatus 100 according to the present exemplary embodiment uses a threshold of 11 fps.

In step S204, if the current frame rate is determined to be lower than the threshold (NO in step S204), the processing proceeds to step S208. If the current frame rate is determined to be higher than or equal to the threshold (YES in step S204), the processing proceeds to step S206.

In step S206, the frame rate control unit 103 performs processing to reduce the frame rate. More specifically, if the current frame rate acquired in step S202 is higher than or equal to 11 fps and the processing load is determined to reach the predetermined load in step S203, the frame rate control unit 103 performs the processing to reduce the frame rate.

As described above, the processing load is not limited to the load of the CPU. For example, the processing load may be a time difference between when the moving image data is input from the video input apparatus 101 and when a packet of the moving image data is transmitted. In such a case, the frame rate control unit 103 may perform the processing in step S206 if the time difference between the time of input and the time of transmission of the moving image data reaches a predetermined value.

The status information acquired in step S201 is not limited to a processing load. For example, the status information may be the number of frames or the amount of data of the moving image data that is stored in the buffer 106 and waiting for transmission. In such a case, the frame rate control unit 103 may perform the processing in step S206 if at least either one of the number of frames and the amount of data of the moving image data that is stored in the buffer 106 and waiting for transmission reaches a predetermined value.

The frame rate control unit 103 according to the present exemplary embodiment determines a changed frame rate so that the higher the current frame rate is, the higher the rate of reduction of the frame rate is. For example, if the current frame rate is 30 fps, the frame rate control unit 103 controls the frame rate so that the changed frame rate is 15 fps. If the current frame rate is 15 fps, the frame rate control unit 103 controls the frame rate so that the changed frame rate is 10 fps.

Suppose that the frame rate control unit 103 reduces the frame rates according to the processing load of the transmission apparatus 100 while the transmission apparatus 100 is transmitting the moving image data at 30 fps and 15 fps. In such a case, in step S206 (i.e., change procedure), the frame rate control unit 103 changes the frame rates in the following manner.

The frame rate control unit 103 changes the frame rates so that the ratio of the former frame rate changed (15 fps) to unchanged (30 fps), −1/2, is higher than the ratio of the latter frame rate changed (10 fps) to unchanged (15 fps), −1/3. In other words, the frame rate control unit 103 changes the frame rates so that the reduction ratio (1/2) of the first frame rate with respect to the unchanged first frame rate (30 fps) is higher than the reduction rate (1/3) of the second frame rate with respect to the unchanged second frame rate (15 fps).

The frame rate control unit 103 may maintain the second frame rate unchanged. More specifically, the reduction rate of the second frame rate may be zero. For example, if the unchanged second frame rate is lower than or equal to a predetermined threshold (for example, 11 fps), the frame rate control unit 103 may control the frame rates so as not to reduce the second frame rate while reducing the first frame rate. In such a manner, the frame rate control unit 103 can change the frame rates while preventing the second frame rate from becoming too low.

If the frame rate is reduced in step S206, the moving image coding unit 102 according to the present exemplary embodiment codes the moving image data at the same frame rate as before the reduction of the frame rate. Further, the packet generation unit 104 generates moving image packets at the reduced frame rate. The moving image coding unit 102 according to the present exemplary embodiment performs the coding processing on a moving image using dedicated hardware.

If the current frame rate acquired in step S202 is lower than 11 fps (NO in step S204), the frame rate control unit 103 does not change the frame rate even though the processing load is determined to be higher than or equal to the threshold in step S203.

After reducing the frame rate in step S206 or if in step S204 the frame rate is determined to be lower than the threshold (11 fps) (NO in step S204), then in step S208, the frame rate control unit 103 determines whether the processing in steps S202 to S207 is completed with respect to all the moving image data pieces. In step S208, if it is determined that the processing is not completed with respect to all the moving image data pieces (NO in step S208), the frame rate control unit 103 returns the processing to step S202. If it is determined that the processing is completed with respect to all the moving image data pieces (YES in step S208), the frame rate control unit 103 ends the processing illustrated in FIG. 2. Returning to step S202, the frame rate control unit 103 acquires an initial frame rate and a current frame rate of the second reception apparatus 302, and performs the processing in step S203 and subsequent steps.

In the present exemplary embodiment, when predetermined time elapses from the end of the processing illustrated in FIG. 2, the transmission apparatus 100 restarts the processing illustrated in FIG. 2. The restart is not limited to after a lapse of the predetermined time. For example, the transmission apparatus 100 may start the processing illustrated in FIG. 2 according to situations such as when error packets increase, when transmission of new moving image data is started, and when transmission of existing moving image data is completed.

In step S203, if the processing load of the transmission apparatus 100 is determined to be lower than the threshold (NO in step S203), then in step S205, the frame rate control unit 103 determines whether the current frame rate acquired in step S202 is lower than its initial frame rate.

In step S205, if the current frame rate is determined to be lower than the initial frame rate (YES in step S205), then in step S207, the frame rate control unit 103 performs processing to increase the current frame rate up to the initial frame rate. For example, suppose that the initial frame rate is 30 fps, and the frame rate has been reduced to 15 fps according to the processing load of the transmission apparatus 100. If the processing load subsequently falls below the threshold, the frame rate control unit 103 restores the current frame rate up to 30 fps.

In other words, the frame rate control unit 103 changes a plurality of changed frame rates into their respective initial frame rates according to the status information (the processing load or the status of the buffer 106).

In the above-described example, the frame rate control unit 103 may determine up to what frame rate to increase the frame rate of 15 fps, based on the current processing load. The frame rate control unit 103 may use different thresholds to determine whether to reduce the frame rate and to determine whether to restore the frame rate. More specifically, a processing load threshold for determining whether to reduce the frame rate (CPU load of 80%) may be higher than a processing load threshold for determining whether to restore the frame rate (CPU load of 60%). Such settings can reduce the frequency of change of a frame rate.

Note that even if the frame rate is increased in step S207, the moving image coding unit 102 according to the present exemplary embodiment codes the moving image data at the same frame rate as before the increase of the frame rate. Such an operation can reduce the frequency of the change in frame rates in the moving image coding unit 102.

In step S205, if the frame rate is determined to have not been reduced (the initial frame rate and the current frame rate have the same value; NO in step S205), the processing proceeds to step S208.

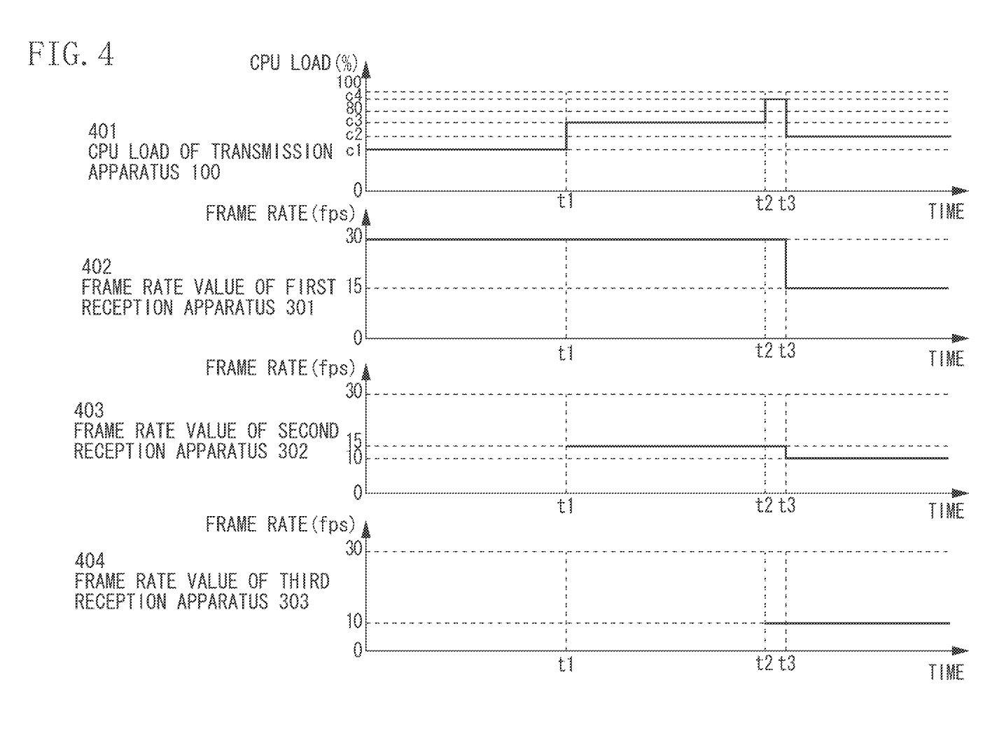

Next, processing of an entire system according to the present exemplary embodiment will be described with reference to FIGS. 3 and 4.

FIG. 3 illustrates an example of connections between the transmission apparatus 100 according to the present exemplary embodiment and the plurality of reception apparatuses 301 to 303. The transmission apparatus 100 and the first reception apparatus 301, the second reception apparatus 302, and the third reception apparatus 303 are connected to each other via a network 304 (corresponding to the transmission path 108 in FIG. 1).

It is assumed that all moving images transmitted to the reception apparatuses 301 to 303 have a video graphic array (VGA; 640*480 pixels) resolution. An initial frame rate for the first reception apparatus 301 is 30 fps, that for the second reception apparatus 302 is 15 fps, and that for the third reception apparatus 303 is 10 fps. In the present exemplary embodiment, the frame rate threshold is set to 11 fps.

FIG. 4 illustrates a relationship over time between the CPU load acquired by the load acquisition unit 105 of the transmission apparatus 100 and the frame rates of moving image data transmitted to the first to third reception apparatuses 301 to 303.

A chart 401 in FIG. 4 illustrates the CPU load acquired by the load acquisition unit 105 of the transmission apparatus 100 over time. It is assumed that, in the present exemplary embodiment, the CPU load threshold is set to 80%. In the period between time 0 and time t1, the CPU load is c1. In the period between time t1 and time t2, the CPU load is c3. In the period between time t2 and time t3, the CPU load is c4. After time t3, the CPU load is c2. Here, c1<c2<c3<80%<c4.

Charts 402 to 404 in FIG. 4 illustrate changes of the frame rates of moving data transmitted to the respective first to third reception apparatuses 301 to 303 over time.

Initially, at time 0, the transmission apparatus 100 starts transmitting moving image data to the first reception apparatus 301. The CPU load here is c1, which is lower than the threshold of 80%. The transmission apparatus 100 therefore transmits the moving image data to the first reception apparatus 301 while maintaining the frame rate at the initial value of 30 fps.

At time t1, the transmission apparatus 100 starts transmitting moving image data to the second reception apparatus 302. The CPU load increases from c1 to c3, which is still lower than the threshold of 80%. The transmission apparatus 100 therefore transmits the moving image data while maintaining the frame rate for the first reception apparatus 301 at the initial value of 30 fps and the frame rate for the second reception apparatus 302 at the initial value of 15 fps.

At time t2, the transmission apparatus 100 starts transmitting moving image data to the third reception apparatus 303. Accordingly, the CPU load is increased from c3 to c4, which exceeds the threshold of 80%.

Then, at time t3, the transmission apparatus 100 performs frame rate control for reducing the frame rates. The period between time t2 and time t3 is the time it takes from when the load acquisition unit 105 acquires the CPU load to when the frame rate control unit 103 reduces the frame rates.

As a result of the frame rate control, the frame rate for the first reception apparatus 301 is reduced from 30 fps to 15 fps, i.e., a half. The frame rate for the second reception apparatus 302 is reduced from 15 fps to 10 fps, i.e., 2/3. In such a manner, the frame rate control unit 103 according to the present exemplary embodiment determines changed frame rates so that the higher the current frame rate is when the processing load of the transmission apparatus 100 reaches or exceeds the threshold, the higher the rate of reduction of the frame rate is.

Note that the frame rate for the third reception apparatus 303 is 10 fps, which is lower than the threshold (11 fps) and is thus kept unchanged. More specifically, the frame rate control unit 103 reduces the frame rates of the moving image data transmitted to the first reception apparatus 301 and the second reception apparatus 302, but not the frame rate of the moving image transmitted to the third reception apparatus 303. Such a frame rate control reduces the CPU load of the transmission apparatus 100 from c4 to c2, which is lower than the threshold of 80%.

As described above, when the frame rate control unit 103 of the transmission apparatus 100 reduces frame rates of moving image data being transmitted, the frame rate control unit 103 determines the changed frame rates so that the higher the frame rate yet to be reduced is, the higher the rate of reduction of the frame rate is. Such an operation can reduce the possibility that the frame rate of a certain piece of moving image data may be excessively reduced by frame rate control when the transmission apparatus 100 is transmitting the moving image data at a plurality of different frame rates.

The present exemplary embodiment has concentrated on the case of transmitting moving image data to a plurality of reception apparatuses at different frame rates. However, an exemplary embodiment of the present invention may be applied when moving image data is transmitted to a single reception apparatus at different frame rates.

The above-described description deals with the case where the frame rate control unit 103 acquires a pair of a current frame rate and a corresponding initial frame rate in step S202 of FIG. 2. However, in step S202, the frame rate control unit 103 may acquire all pairs of current frame rates and initial frame rates of moving image data being transmitted. In such a case, if in step S203 the processing load is determined to be higher than or equal to the threshold (YES in step S203), the frame rate control unit 103 determines whether the plurality of current frame rates acquired in step S202 includes one or more frame rates that is/are higher than or equal to the threshold. If there is any such frame rate, then in step S206, the frame rate control unit 103 performs frame rate control to reduce the frame rate.

Now, suppose that a first changed frame rate into which a first initial frame rate is changed and a second changed frame rate into which a second initial frame rate is changed are the same. If a further reduction in frame rate is intended, the frame rate control unit 103 performs the following control.

The frame rate control unit 103 controls the frame rates so that a third changed frame rate into which the first changed frame rate is changed is higher than a fourth changed frame rate into which the second changed frame rate is changed, providing that the first initial frame rate is higher than the second initial frame rate. In such a manner, the frame rate control unit 103 can control frame rates closer to a user request if the current frame rates for a plurality of reception apparatuses are the same.

The frame rate control unit 103 may control frame rates based on the resolution of moving image data being transmitted. For example, in the case illustrated in FIG. 3, suppose that the moving image data transmitted to the first reception apparatus 301 is in Quad-VGA (1280*960 pixels) resolution. In such a case, the frame rate control unit 103 may reduce the frame rate to below 15 fps. Then, the frame rate control unit 103 may set the frame rate of the moving image data transmitted to the second reception apparatus 302 (in VGA size) to above 15 fps. Such an operation can reduce the possibility that a certain piece of moving image data may become too low in quality. A resolution-based frame rate control will be described in detail in a second exemplary embodiment.

A second exemplary embodiment will be described with a focus on differences from the first exemplary embodiment.

The present exemplary embodiment deals with a case where pieces of moving image data to be transmitted have different resolutions.

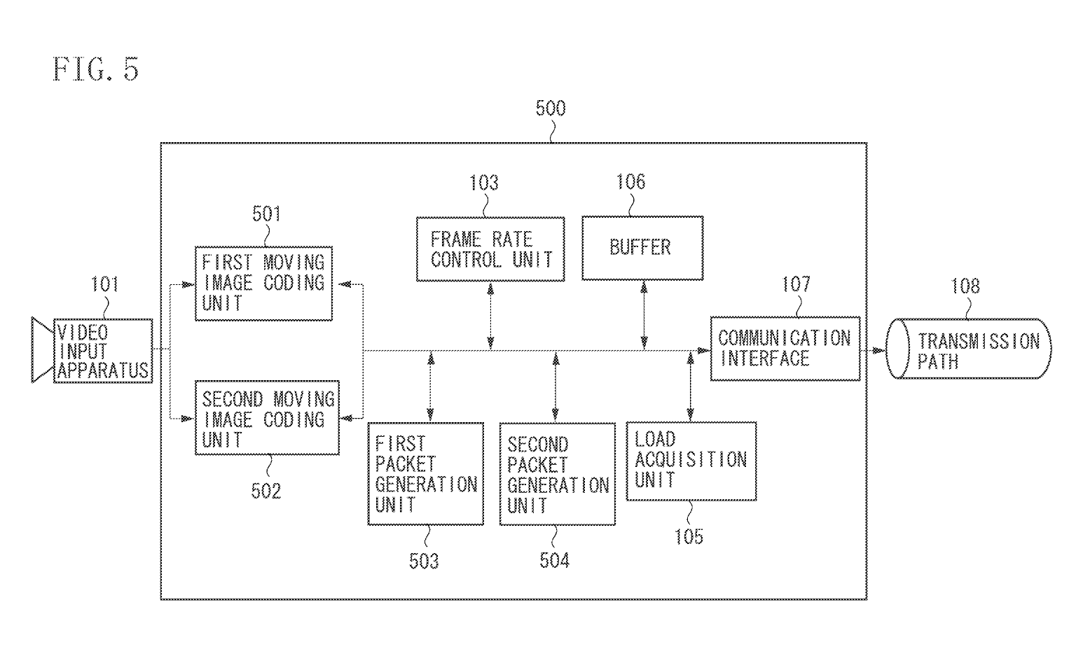

FIG. 5 is a block diagram illustrating an example of a functional configuration of a transmission apparatus 500 according to the second exemplary embodiment. As illustrated in FIG. 5, the transmission apparatus 500 according to the present exemplary embodiment includes a first moving image coding unit 501, a second moving image coding unit 502, a first packet generation unit 503, and a second packet generation unit 504. In FIG. 5, components similar to those in FIG. 1 are designated by the same reference numerals.

The first moving image coding unit 501 compresses and codes moving image data input from the video input apparatus 101 by the Quad-VGA (1280*960 pixels) Motion-JPEG method. The first moving image coding unit 501 inputs the compressed and coded moving image data into the first packet generation unit 503 frame by frame.

The second moving image coding unit 502 compresses and codes moving image data input from the video input apparatus 101 by the VGA (640*480 pixels) Motion-JPEG method. The second moving image coding unit 502 inputs the compressed and coded moving image data into the second packet generation unit 504 frame by frame.

The first packet generation unit 503 and the second packet generation unit 504 packetize the moving image data input from the first moving image coding unit 501 and the second moving image coding unit 502, respectively, and store the resulting packets into the buffer 106. Similar to the packet generation unit 104 according to the first exemplary embodiment, the first packet generation unit 503 and the second packet generation unit 504 according to the present exemplary embodiment packetize the coded moving image data according to IETF RFC 2435 which defines the RTP payload format.

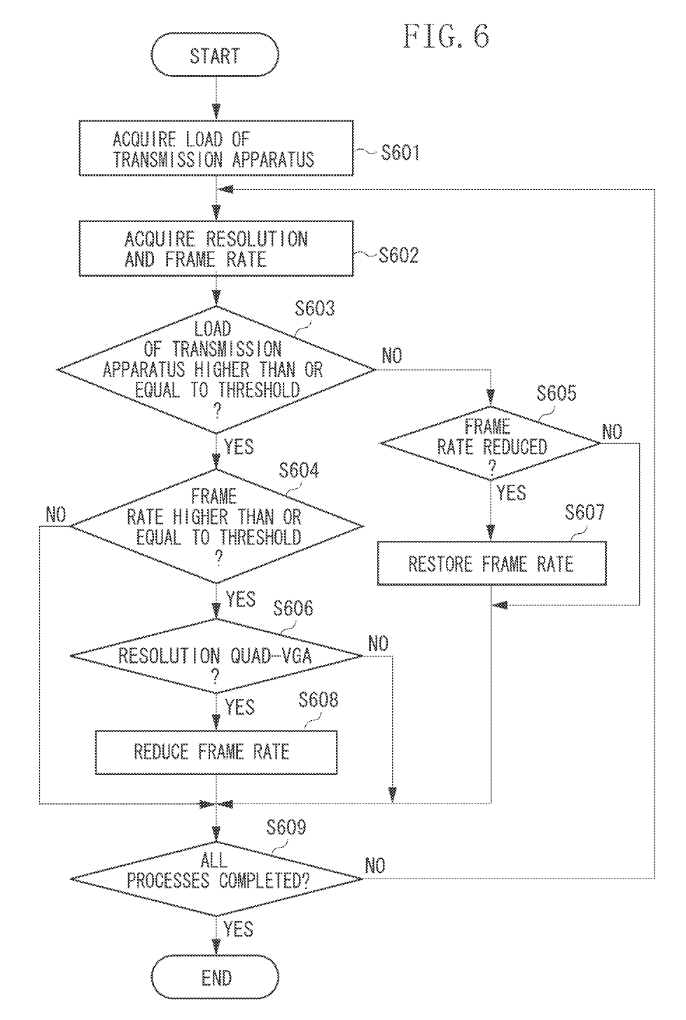

Next, frame rate control processing of the transmission apparatus 500 according to the present exemplary embodiment will be described in detail with reference to FIG. 6. FIG. 6 is a flowchart illustrating the frame rate control processing of the transmission apparatus 500 according to the present exemplary embodiment. The transmission apparatus 500 according to the present exemplary embodiment is a transmission apparatus that can transmit moving image data at a plurality of different frame rates. The transmission apparatus 500 according to the present exemplary embodiment performs the processing illustrated in FIG. 6 by its CPU reading and executing a program for executing the processing illustrated in FIG. 6.

At least a part of the processing illustrated in FIG. 6 may be performed by dedicated hardware. The transmission apparatus 500 according to the present exemplary embodiment starts the processing illustrated in FIG. 6 at timing when the transmission apparatus 500 starts transmitting moving image data to the reception apparatus. In the present exemplary embodiment, the transmission apparatus 500 transmits Quad-VGA moving image data to a first reception apparatus and VGA moving image data to a second reception apparatus.

In step S601, the load acquisition unit 105 initially acquires current status information about the transmission apparatus 500. Similar to the first exemplary embodiment, the status information refers to information about the processing load of the transmission apparatus 500, and the amount of data and the number of frames of moving image data that is stored in the buffer 106 and waiting for transmission. The following description deals mainly with the case of using the processing load of the transmission apparatus 500 as the status information.

In step S602, a frame rate control unit 103 acquires the values of resolution and a frame rate of moving image data to be transmitted to each reception apparatus. In the present exemplary embodiment, the transmission apparatus 500 transmits Quad-VGA moving image data to the first reception apparatus and VGA moving image data to the second reception apparatus. The method for acquiring the frame rate is similar to that in the first exemplary embodiment.

The processing in steps S603 to S605 and S607 corresponds to that in steps S203 to S205 and S207 according to the first exemplary embodiment.

In step S604, if the current frame rate acquired in step S602 is determined to be higher than or equal to the threshold (YES in step S604), then in step S606, the frame rate control unit 103 determines whether the resolution of the moving image data transmitted at the current frame rate is Quad-VGA. If the resolution is determined to be Quad-VGA (YES in step S606), the processing proceeds to step S608. If the resolution is determined to be not Quad-VGA (determined to be VGA; NO in step S606), the processing proceeds to step S609.

In step S606, if the resolution is determined to be Quad-VGA (YES in step S606), then in step S608, the frame rate control unit 103 reduces the frame rate of the Quad-VGA moving image data. In other words, if the processing load of the transmission apparatus 500 reaches or exceeds the threshold, the frame rate control unit 103 according to the present exemplary embodiment reduces the frame rate of the moving image data that has a predetermined or higher resolution (Quad-VGA). On the other hand, the frame rate control unit 103 does not reduce the frame rate of the moving image data below the predetermined resolution (VGA) even if the processing load reaches or exceeds the threshold. Examples of the predetermined resolution are not limited to Quad-VGA.

Even if the frame rate is reduced in step S608, the first moving image coding unit 501 according to the present exemplary embodiment codes the moving image at the same frame rate as before the reduction of the frame rate. The first packet generation unit 503 generates moving image packets at the reduced frame rate. The first moving image coding unit 501 and the second moving image coding unit 502 according to the present exemplary embodiment perform the coding processing on a moving image using dedicated hardware.

In step S609, the frame rate control unit 103 determines whether the processing in steps S602 to S608 is completed with respect to all the moving image data pieces being transmitted. If it is determined that the processing is not completed (NO in step S609), the frame rate control unit 103 returns to step S602.

On the other hand, if in step S609 it is determined that the processing is completed with respect to all the moving image data pieces (YES in step S609), the frame rate control unit 103 ends the processing illustrated in FIG. 6. In the present exemplary embodiment, when predetermined time elapses from the end of the processing illustrated in FIG. 6, the transmission apparatus 500 restarts the processing illustrated in FIG. 6. The restart is not limited to after a lapse of the predetermined time. For example, the transmission apparatus 500 may start the processing illustrated in FIG. 6 according to situations such as when error packets increase, when transmission of new moving image data is started, and when transmission of existing moving image data is completed.

As described above, the frame rate control unit 103 of the transmission apparatus 500 reduces the frame rate of moving image data that has a predetermined or higher resolution according to the processing load of the transmission apparatus 500. Such an operation can reduce the possibility that a certain piece of moving image data may become too low in quality because of frame rate control.

The present exemplary embodiment deals with the case where the frame rate control unit 103 reduces the frame rate of the moving image data that has the predetermined or higher resolution but not the frame rate of the moving image data below the predetermined resolution when the processing load of the transmission apparatus 500 reaches or exceeds the predetermined value. However, the present exemplary embodiment is not limited to the above-described configuration. For example, the frame rate control unit 103 may determine the amount of reduction of a frame rate according to the resolution of moving image data being transmitted.

For example, suppose that the transmission apparatus 500 transmits Quad-VGA moving image data to the first reception apparatus at 30 fps and VGA moving image data to the second reception apparatus at 30 fps. When the processing load of the transmission apparatus 500 reaches or exceeds the threshold, the frame rate control unit 103 may control the frame rates in the following manner.

The frame rate control unit 103 may reduce the frame rate of the moving image data transmitted to the first reception apparatus to 15 fps, and then reduce the frame rate of the moving image data transmitted to the second reception apparatus to 20 fps according to the subsequent processing load. Instead of the processing load, other status information (such as the number of frames and the amount of data of the moving image data that is stored in the buffer 106 and waiting for transmission) may be used.

As described above, the frame rate control unit 103 controls frame rates so that the higher the resolution of moving image data is, the higher the rate of reduction of the frame rate is. Such a frame rate control can reduce the possibility that a certain piece of moving image data may become too low in quality.

In the above-described exemplary embodiments, the transmission apparatus has the function of performing coding of moving image data. However, the moving image coding unit(s) and the transmission apparatus may be configured as separate apparatuses.

The above-described exemplary embodiments deals with the cases of using RTP as a data transfer protocol. However, the data transfer protocol is not limited to RTP. Other protocols in the same layer of the open systems interconnection (OSI) reference model and other protocols in other layers may also be used.

While exemplary embodiments of the present invention have been described in detail above, the present invention may be practiced, for example, as a system, an apparatus, a method, a program, a recording medium (a storage medium), and/or other modes of embodiment.

Aspects of the present invention can also be realized by a computer of a system or apparatus (or devices such as a CPU or an MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-059248 filed Mar. 17, 2011, which is hereby incorporated by reference herein in its entirety.

What is claimed is:

1. A transmission apparatus capable of transmitting moving image data at a plurality of different frame rates, the transmission apparatus comprising:
an acquisition unit configured to acquire status information about the transmission apparatus;
a transmission unit configured to transmit moving image data; and
a change unit configured to, when the transmission unit is transmitting the moving image data at a first frame rate and a second frame rate which is lower than the first frame rate and if the frame rates of the moving image data which is being transmitted are reduced according to the status information, reduce the first frame rate and the second frame rate so that a reduction rate of the first frame rate with respect to the first frame rate is higher than a reduction rate of the second frame rate with respect to the second frame rate.

2. The transmission apparatus according to claim 1, wherein the acquisition unit acquires a processing load of the transmission apparatus to transmit the moving image data at the first frame rate and the second frame rate as the status information, and
wherein the change unit reduces the first and second frame rates when the processing load reaches a predetermined load.

3. The transmission apparatus according to claim 1, further comprising an input unit configured to input moving image data to be transmitted,
wherein the acquisition unit acquires processing time as the status information, the processing time relating to time between when the input unit inputs the moving image data and when the moving image data is transmitted, and
wherein the change unit reduces the first and second frame rates when the processing time reaches a predetermined time.

4. The transmission apparatus according to claim 1, further comprising a storage unit configured to store moving image data waiting for transmission,
wherein the acquisition unit acquires at least either one of a number of frames of the moving image data waiting for transmission and an amount of data of the moving image data waiting for transmission as the status information, and
wherein the change unit reduces the first and second frame rates if at least either one of the acquired number of frames and the acquired amount of data reaches a predetermined value.

5. The transmission apparatus according to claim 1, wherein when the transmission unit is transmitting moving image data at the first frame rate, the second frame rate, and a third frame rate which is lower than the second frame rate and the change unit changes the first and second frame rates, the change unit does not reduce the third frame rate if the third frame rate is lower than a predetermined frame rate.

6. The transmission apparatus according to claim 1, wherein if a first changed frame rate into which the first frame rate is changed and a second changed frame rate into which the second frame rate is changed are the same frame rate and the change unit further reduces the frame rate of the moving image data being transmitted according to status information acquired after the change, the change unit reduces the first changed frame rate and the second changed frame rate so that a fourth changed frame rate into which the second changed frame rate is changed is lower than a third changed frame rate into which the first changed frame rate is changed.

7. The transmission apparatus according to claim 1, wherein the change unit changes a first changed frame rate into which the first frame rate is changed into the first frame rate before the change and a second changed frame rate into which the second frame rate is changed into the second frame rate before the change according to the status information.

8. A transmission apparatus capable of transmitting moving image data in a plurality of different resolutions, the transmission apparatus comprising:
an acquisition unit configured to acquire status information about the transmission apparatus;
a transmission unit configured to transmit moving image data; and
a control unit configured to, when the transmission unit is transmitting moving image data having a first resolution and moving image data having a second resolution which is lower than the first resolution and if a frame rate of the moving image data being transmitted is reduced according to the status information, reduce a frame rate of the moving image data having the first resolution and determine whether to reduce a frame rate of the moving image data having the second resolution according to status information acquired after the frame rate of the moving image data having the first resolution is reduced.

9. A method for transmission executed by a transmission apparatus capable of transmitting moving image data at a plurality of different frame rates, the method comprising:
acquiring status information about the transmission apparatus;
transmitting moving image data; and
when the moving image data is being transmitted at a first frame rate and a second frame rate which is lower than the first frame rate and if the frame rates of the moving image data which is being transmitted are reduced according to the status information, reducing the first frame rate and the second frame rate so that a reduction rate of the first frame rate with respect to the first frame rate is higher than a reduction rate of the second frame rate with respect to the second frame rate.

10. The method according to claim 9, further comprising:
acquiring a processing load of the transmission apparatus to transmit the moving image data at the first frame rate and the second frame rate as the status information; and
reducing the first and second frame rates when the processing load reaches a predetermined load.

11. The method according to claim 9, further comprising:
acquiring processing time as the status information, the processing time relating to time between when moving image data to be transmitted is input and when the moving image data is transmitted, and
reducing the first and second frame rates when the processing time reaches a predetermined time.

12. The method according to claim 9, further comprising:
acquiring at least either one of a number of frames of the moving image data waiting for transmission and an amount of data of the moving image data waiting for transmission as the status information, and
reducing the first and second frame rates if at least either one of the acquired number of frames and the acquired amount of data reaches a predetermined value.

13. A method for transmitting moving image data in a plurality of different resolutions, the method comprising:
acquiring status information about the transmission apparatus;
transmitting moving image data; and
when moving image data having a first resolution and moving image data having a second resolution which is lower than the first resolution are being transmitted and if a frame rate of the moving image data being transmitted is reduced according to the status information, reducing a frame rate of the moving image data having the first resolution and determining whether to reduce a frame rate of the moving image data having the second resolution according to status information acquired after the frame rate of the moving image data having the first resolution is reduced.

14. A computer-readable recording medium storing a program causing a computer capable of transmitting moving image data at a plurality of different frame rates to execute:
an acquisition procedure for acquiring status information about the computer;
a transmission procedure for transmitting moving image data; and
a change procedure for, when the moving image data is being transmitted at a first frame rate and a second frame rate which is lower than the first frame rate in the transmission procedure and if the frame rates of the moving image data which is being transmitted are reduced according to the status information, reducing the first frame rate and the second frame rate so that a reduction rate of the first frame rate with respect to the first frame rate is higher than a reduction rate of the second frame rate with respect to the second frame rate.

15. The computer-readable recording medium according to claim 14, wherein the program further causes the computer to execute:
in the acquisition procedure, processing of acquiring a processing load of the computer to transmit the moving image data at the first frame rate and the second frame rate as the status information, and
in the change procedure, processing of reducing the first and second frame rates when the processing load reaches a predetermined load.

16. The computer-readable recording medium according to claim 14, wherein the program further causes the computer to execute:
in the acquisition procedure, processing of acquiring processing time as the status information, the processing time relating to time between when moving image data to be transmitted is input and when the moving image data is transmitted, and
in the change procedure, processing of reducing the first and second frame rates when the processing time reaches a predetermined time.

17. The computer-readable recording medium according to claim 14, wherein the program further causes the computer to execute:
in the acquisition procedure, processing of acquiring at least either one of a number of frames of the moving image data waiting for transmission and an amount of data of the moving image data waiting for transmission as the status information, and
in the change procedure, processing of reducing the first and second frame rates if at least either one of the acquired number of frames and the acquired amount of data reaches a predetermined value.

18. A computer-readable recording medium storing a program causing a computer capable of transmitting moving image data at a plurality of different frame rates to execute:
an acquisition procedure for acquiring status information about the computer;
a transmission procedure for transmitting moving image data; and
a control procedure for, when moving image data having a first resolution and moving image data having a second resolution which is lower than the first resolution are being transmitted in the transmission procedure and if a frame rate of the moving image data being transmitted is reduced according to the status information, reducing a frame rate of the moving image data having the first resolution and determining whether to reduce a frame rate of the moving image data having the second resolution according to status information acquired after the frame rate of the moving image data having the first resolution is reduced.
